(19) United States
(12) Patent Application Publication
(10) Pub. No.: US 2007/0021283 A1
(43) Pub. Date: Jan. 25, 2007

(54) System and method for the automated folding of textiles

(76) Inventors: Richard Leifer, Melville, NY (US); Alan Randmae, Northport, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/184,138

(22) Filed: Jul. 19, 2005

(51) Int. Cl. B31B 1/00

(52) U.S. Cl. 493/23

(57) ABSTRACT

A system and method for automated identification and folding of textile items. A folding unit includes an item identifier for identifying, for example, an article of clothing and matching its identification with a corresponding stored article ID in a memory database. Preferably, each textile item is embedded with a readable tag or transponder (e.g., RFID) for reading by the item identifier. The system also allows for reversion to a default folding mode if e.g., no match is found. Additionally, folding codes may be manually entered and/or created for e.g., articles with no readable tag and/or no matching folding code. Advantageously, a system and method according to the present invention is interactive in providing users with, e.g., the option to select from, as well as input, various folding arrangements and techniques.

### TECHNICAL FIELD OF THE INVENTION

The present invention generally relates to automated folding of textile items and, more particularly, to a system and method for automatically identifying, sorting and folding different textile items such as clothing, towels, blankets, etc.

### BACKGROUND OF THE INVENTION

In the interest of, e.g., efficient laundry processing, various automated folding units have been developed in the prior art. Exemplary prior art folding units include laundry folding machines which typically use a series of conveyor belts on which laundry pieces are fed and means for centering the pieces relative to a longitudinal center line, wherein pieces are folded about the center line. Details of the means for centering and folding about a center line are set forth in U.S. Pat. No. 4,059,257, the disclosure of which is incorporated by reference.

Other laundry folding machines are typically directed towards processing flat-work articles such as towels, sheets, tablecloths, etc. as discussed in U.S. Pat. Nos. 5,921,908, 4,234,179, 4,738,440 and 4,678,173, the disclosures of which are incorporated by reference.

Automated folding apparatuses which use opposed air blasts in forming folds in sheet material are disclosed in U.S. Pat. Nos. 5,300,007, 5,435,802 and 5,556,360, the disclosures of which are incorporated by reference.

In addition, various prior art folding machines are taught for automated creation of folds in non-clothing articles such as corrugated cardboard, utilizing pulleys and conveyer belts, which are disclosed in U.S. Pat. No. 4,614,512, the disclosure of which is incorporated by reference. A folding apparatus for production of disposable articles having a side flap folded inwardly is taught in U.S. Pat. No. 4,682,977, the disclosure of which is incorporated by reference.

However, all such known devices have limitations, among them the inability to accurately assess and discern an article and fold according to the type and configuration of the article.

Accordingly, a need exists for a system and method for efficiently and effectively folding textile articles regardless of, e.g., a shape and size of an article, in a convenient manner that overcomes the limitations of the prior art.

### SUMMARY OF THE INVENTION

The present invention provides for accurate and efficient automated identification, sorting and customized folding of articles of clothing. In its heretofore disclosed system and method, the present invention overcomes the prior art limitations described above via its overall flexibility in providing automated folding appropriate for/customized to the type of article of clothing desired to be folded.

In one aspect, the present invention provides a method of automated folding comprising the steps of providing a folding unit having a memory for storing a plurality of folding codes, wherein each folding code is matched to at least one article ID. An article having a tag with an article ID is provided and the article is scanned with an item identifier to read said article ID. The article ID is compared with said plurality of folding codes, and if a match is found, the article is folded according to the matching folding code.

In another aspect, the present invention provides a method for automated folding of a textile item comprising the steps of identifying the textile item using an item identifier and forwarding the item to an automatic folder for folding in response to the identification of the item.

These, and other aspects, features and advantages of the present invention will be described or become apparent from the following detailed description of the preferred embodiments, which is to be read in connection with the accompanying drawings.

### BRIEF DESCRIPTION OF THE DRAWINGS

In the drawings, wherein like reference numerals denote similar elements throughout the views:

FIG. 1 is an exemplary schematic illustration of an automated folding unit 100 according to an aspect of the present invention; and

FIG. 2 illustrates a flowchart of an exemplary method of automatically processing and folding a textile item according to an aspect of the present invention.

It should be understood that the drawings are for purposes of illustrating the concepts of the invention and are not necessarily the only possible configurations for illustrating the invention.

### DETAILED DESCRIPTION OF THE INVENTION

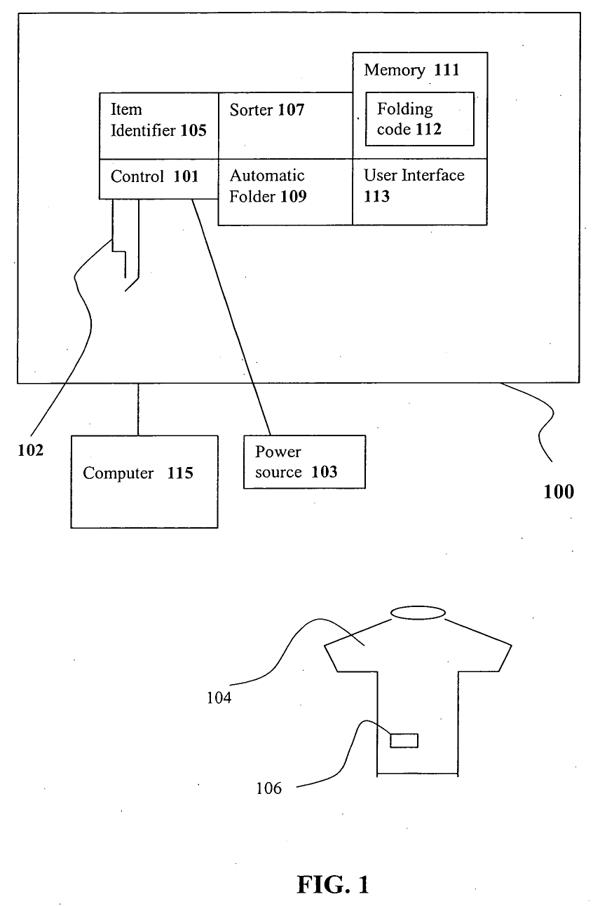

Referring now to the Figures, FIG. 1 is an exemplary schematic illustration of an automated folding unit 100 according to an aspect of the present invention. The folding unit 100 preferably includes a memory 111 for storing a database comprising e.g., code for various folding protocols for directing an automatic folder 109 to fold an article of clothing according to the type of article which has been identified by an item identifier 105, e.g., one code may include instructions for directing a folder 109 to follow a sequence of events and movements to fold a button-down shirt, while another code may include instructions for folding slacks.

Such codes may be pre-programmed into the unit 100 e.g., by the manufacturer, or input by a user via a user interface 113 or a computer 115. The user interface 113 may comprise e.g., a graphical user interface provided directly on the unit 100; alternatively or in addition, the unit 100 may be enabled to communicate with the computer 115 (or other data entry device) for facilitating data input. Advantageously, the present invention permits users to enter or select specific folding protocols according to, e.g., personal preferences for folding different clothing articles, and thus customize the way each particular item of clothing is folded.

The item identifier 105 is provided for assessing and identifying an article of clothing to be folded. In a preferred embodiment, the item identifier 105 may comprise a radio frequency identification (RFID) system, wherein the identifier 105 itself comprises e.g., a reader (i.e., an antenna and transceiver). In this embodiment, an article of clothing 104 is preferably provided with a radio frequency identification (RFID) transponder or tag 106, which may be passive or active. The reader is used to transmit a signal to the tag 106, which is then activated and transmits data back to the antenna. Such data is processed by the identifier 105 using e.g., any known techniques, for purposes of processing and retrieving information related to the article (e.g., identifying the type of article of clothing, its folding instructions, etc.)

Various other means for item identification may be contemplated, including, but not limited to, bar code scanning systems, photoreceptor drums, etc.???

Upon identification of the type of clothing article, it is compared with and matched to the appropriate folding code(s) 112 stored in memory 111 and the folder 109 automatically folds the article accordingly. At least one, preferably, a plurality of folding codes 112 is saved in the memory 111. It is noted that specific folding instructions may be stored either in memory 111 or in each tag 106.

In one embodiment, if more than one match (i.e., matching folding code) is found, user interface 113 preferably displays to the user all the possible matches found, wherein the user can select the desired folding code from the matches. The user may thereinafter set the selected folding code as the default folding method for that particular item as well as items which are similar. In another embodiment, the folder 109 is enabled to ensure each clothing item is turned ‘right-side out’ via e.g., information retrieved from the item identifier 105 as a result of the scanning of the transponder 106.

In an alternate embodiment, the unit 100 may include a default mode (stored in memory 111) directing the folder 109 to fold a clothing article, e.g., according to any preset standard folding method (e.g., along a center line). Such default mode may be set by the user via, e.g., the user interface 113 prior to operation of the unit 100, so as to override the item identifier 105 and direct the folder 109 to fold all items of clothing according to the standard folding method, regardless of clothing type. Alternatively, the default mode could be set to be automatically implemented whenever no tag is found during a scanning process. Methods for locating and folding along a center line are disclosed in the prior art.

As an additional feature, the unit 100 may also optionally include a sorter 107 for automatically sorting the articles of clothing identified by the identifier 105 into various categories (e.g., children's clothing, towels, formal wear, hangered items, dresses, etc.) The sorting may be conducted prior to or during the automated folding operation such that items of clothing in different categories are placed, e.g., in separate piles upon completion of folding to facilitate discernment of the separate categories.

The automated folding may be carried out via any of a variety of techniques and mechanical means using conveyor belts, pulleys, guides, rollers, robotic arms, etc. to achieve the desired folding arrangement and further, to sort clothing, e.g., in different piles, if desired. In the RFID embodiment, each article of clothing preferably has a transponder/tag 106 which includes information on the appropriate clothing article identifier. The transponder 106 may be either pre-installed onto the clothing (e.g., by the manufacturer) or attached to the clothing manually by the user. Attachment of the tags 106 may be achieved via sewing, use of adhesives, etc. to attach at least one tag 106 at any location/position on the clothing.

A control 101 controls at least all of the elements 105, 107, 109, 111 and 113 of the unit 100. The control 101 is also connected to an on/off switch 102 and power source 103, which may comprise, e.g., an external or internal power source.

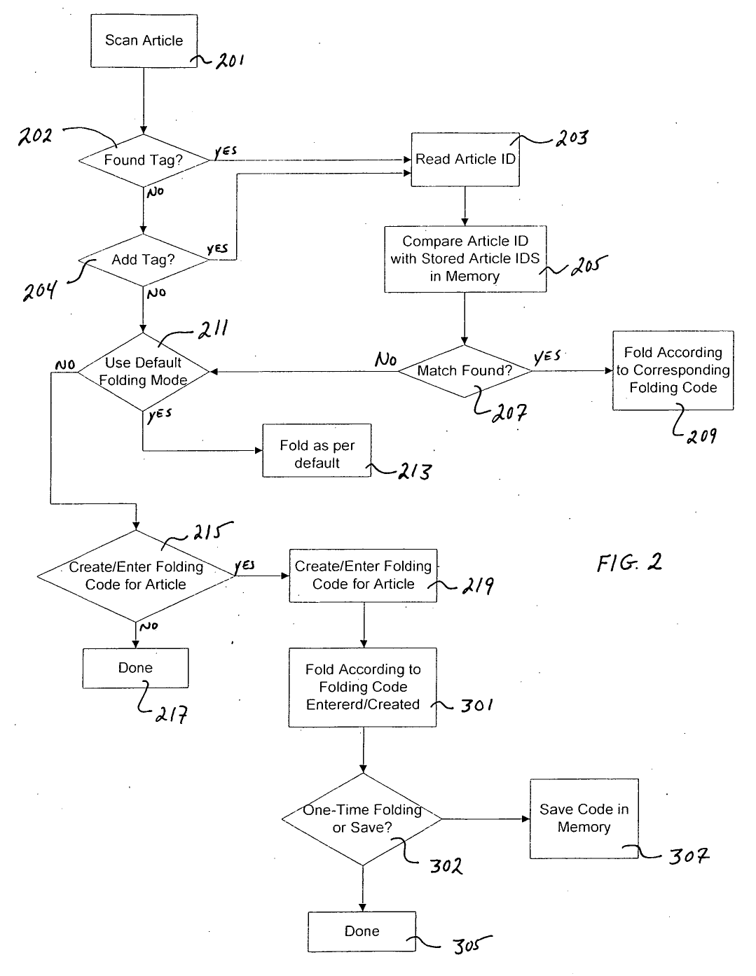

FIG. 2 illustrates a flowchart of an exemplary method of automatically assessing and folding an article according to an aspect of the present invention. In step 201, the unit 100 scans an article (e.g., a textile/clothing article); preferably, in one embodiment as discussed above, the unit 100 is equipped with a scanning device, e.g., an RFID reader comprising an antenna and transceiver, which operates as an item identifier.

Decision step 202 assesses if a readable tag (e.g., a radio frequency identification (RFID) transponder) has been found. If yes, the tag is read and its identification processed (step 203) and the article ID is compared with article IDs stored in the unit's memory (step 205). The article IDs preferably are linked with corresponding folding code and/or instructions readable by the unit 100 for directing the appropriate folding process for the particular article being assessed.

Step 207 assesses if a match is found; if yes, the article is folded according to the corresponding folding code of the matching article ID. If no match is found, the process proceeds to decision step 211 which inquires if a default folding mode is to be used. If yes, the article is folded as per a default setting (step 213). Preferably, there is at least one default setting which may be pre-set by e.g., the user-or pre-installed on the unit 100. The default mode typically may include standard or customized instructions for folding (e.g., folding of all articles along a center line).

If a default folding mode is not selected, it is assessed in decision step 215 whether it is desired to create (e.g., manually enter) a new folding code for the article. If yes, the folding code may be entered (step 219) and the process goes to step 301. If no, the process is done (step 217).

Advantageously, in one embodiment the present invention provides the ability to input and store customized instructions for handling/folding various articles of clothing. Such instructions may be customized as desired by the user, e.g., to accommodate particular shapes/sizes of different articles, various preferences in folding patterns and designs, etc.

If at decision step 202 it is assessed that no readable tag or transponder has been found, the unit inquires if a tag or transponder is desired to be added/attached to the article (step 204). If yes, a tag (preferably with an appropriate folding code for that article) is attached to the article and the process proceeds to step 203. If no, the process proceeds to step 211.

According to another aspect, the present invention provides the user with the option of saving an entered folding code. For example, upon folding the article according to a folding code which has been created/entered for it (step 301) (typically such entry is made manually by a user and is customized to that particular article), the process proceeds to decision step 302, in which a choice is provided between ‘one-time folding’ (e.g., the article was folded according to the entered code for that time only and the entered code will not be saved) or saving the entered code into memory, thus making it available for future use. If saving the entered code is selected, the process proceeds to step 307 and the code is saved into memory. If a one-time folding mode is selected, the code is not saved and the process is done (step 305).

Advantageously, the present invention may conveniently be updated, instructed, programmed and customized as desired to fold virtually any article of clothing. In one embodiment, users may be provided with a variety of RFID tags having pre-determined folding codes for attachment to, e.g., corresponding items. Articles of clothing may be provided with tags pre-attached e.g., by the manufacturer.

Alternative options, settings and embodiments may be contemplated, including but not limited to, e.g., setting the default mode to be automatically exercised whenever a match is not found and no user input (e.g., responses to decision steps) is provided; sorting the articles according to specified categories and then folding each entire category in a designated manner (e.g., as desired by the user); performing a check prior to commencing folding to ensure the article is turned right-side out; separating/placing items that must be placed on a clothes hanger as opposed to folding (e.g., based on data read from the article's tag).

Although the embodiment which incorporates the teachings of the present invention has been shown and described in detail herein, those skilled in the art can readily devise many other varied embodiments that still incorporate these teachings. Having described preferred embodiments for a system and method for automated folding (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A method of automated folding comprising the steps of:
providing a folding unit having a memory for storing a plurality of folding codes, each folding code matched to at least one article ID;
providing an article having a tag with an article ID;
scanning the article with an item identifier to read said article ID; and
comparing said article ID with said plurality of folding codes, wherein if a match is found, further comprising the step of folding the article according to the matching folding code.

2. The method of claim 1, wherein the item identifier comprises a radio frequency identification (RFID) reader.

3. The method of claim 1, wherein the tag comprises a radio frequency identification (RFID) transponder.

4. The method of claim 1, wherein if no match is found, further comprising the step of providing a default folding mode option.

5. The method of claim 4, wherein if the default mode option is not exercised, further comprising the step of providing an option to enter a folding code for the article.

6. The method of claim 5, wherein if a folding code is entered, further comprising the step of folding the article according to the entered code and providing an option to save the code in the memory.

7. A method for the automated folding of a textile item comprising the steps of:
identifying the textile item using an item identifier; and
forwarding the item to an automatic folder for folding in response to the identification of the item.

8. The method of claim 7, wherein the item identifier comprises a radio frequency identification (RFID) reader.

9. The method of claim 8, wherein the textile item includes a radio frequency identification (RFID) transponder attached thereto for identification by the item identifier.

10. The method of claim 7, wherein the automatic folder is connected to a memory which includes at least one pre-programmed folding code.

11. The method of claim 10, wherein the step of folding comprises folding the textile item according to a folding code corresponding to the identification of the item.

12. The method of claim 7, wherein the automatic folder is connected to a user interface for entering a user-specified folding code.

13. The method of claim 12, wherein if a user-specified folding code is entered, further comprising the step of folding the textile item according to the user-specified entered code.

14. The method of claim 13, further comprising the step of providing a user option to save the code in a memory connected to the automatic folder.

15. The method of claim 7, wherein the step of folding comprises folding the textile item according to a default folding mode.

16. A method for the automated folding of a textile item comprising the steps of:
identifying the textile item using an item identifier; and
automatically folding the item in response to the identification of the textile item.

17. The method of claim 16, wherein the item identifier comprises a radio frequency identification (RFID) reader.

18. The method of claim 16, wherein the textile item includes a radio frequency identification (RFID) transponder attached thereto for identification by the item identifier.

19. The method of claim 7, wherein the said folding is performed by a folding machine for the identified textile.

20. The method according claim 19, further comprising providing a memory for the folding machine, said memory including at least one pre-programmed folding code.

21. The method of claim 19, further comprising providing a user interface connected to the automatic folding machine, said user interface enabling a user interface to enter a user-specified folding code.

22. The method of claim 21, further comprising the step of folding the textile item according to the user-specified entered code, when a user-specified folding code has been entered.

23. A system for automatically folding of a textile item comprising:
means for identifying a type of textile item to be folded; and
at least one folding machine adapted to receive and fold an identified textile item.

24. The system according to claim 23, wherein said means for identifying comprises:
a radio frequency identification (RFID) transponder integrated and/or attached to the textile; and
a radio frequency identification (RFID) reader positioned to read the RFID transponder.

25. The system according to claim 23, further comprising a plurality of folding machines each adapted to fold the textile item according to a predetermined folding pattern, wherein said textile is forwarded to one of said plurality of folding machines in response to the identification of the same.
